(19) United States
(12) Patent Application Publication
(10) Pub. No.: US 2009/0055053 A1
(43) Pub. Date: Feb. 26, 2009

(54) SYSTEM AND METHOD FOR PROTECTING A MOTORCYCLE RIDER

(76) Inventor: Yoram Carmeli, Livingston, NJ (US)

Correspondence Address: WEITZMAN LAW OFFICES, LLC, 425 EAGLE ROCK AVENUE, SUITE 102, ROSELAND, NJ, 07068, US

(21) Appl. No.: 12/195,312

(22) Filed: Aug. 20, 2008

Related U.S. Application Data
(60) Provisional application No. 60/968,065, filed on Aug. 26, 2007.

(51) Int. Cl. B60R 21/16

(52) U.S. Cl. 701/45; 2/456

(57) ABSTRACT

A system and method for deploying an airbag in an airbag equipped garment worn by a rider of a vehicle. The system and method comprise a controller for determining when to inflate the airbag within the garment. A first sensor provides a signal to the controller representing the riding angle of the vehicle relative to a vertical orientation. A second sensor provides a signal to the controller representing a current condition of the vehicle. The controller compares the riding angle to a first predetermined threshold indicative of the maximum desired riding angle associated with the current condition of the vehicle and transmits a signal to inflate the airbag when the riding angle exceeds the first predetermined threshold.

### CROSS-REFERENCE TO RELATED APPLICATION

This application claims the benefit of U.S. Provisional Patent Application No. 60/968,065, filed Aug. 26, 2007, the entire disclosure of which is incorporated by reference herein.

### FIELD

This application relates generally to air bag devices, and more particularly, to an air bag device for protecting a rider of a motorcycle or other recreational vehicle.

### BACKGROUND

Most automobiles today include air bag devices to protect the occupants of the vehicle. Conventional air bag devices inflate rapidly in the event of a collision to absorb energy from the movement of the occupant, reduce the chances that an occupant will strike the automobile's interior, and distribute impact forces more evenly across the body of the occupant. Such devices were first used in passenger vehicles in the United States in the mid-1970s, and are now required on passenger cars and light trucks sold in the United States.

Motorcycles have a higher fatality rate per unit distance traveled than automobiles. In addition, the chances of injury while riding a motorcycle or other recreational vehicle (e.g., all terrain vehicle, snowmobile, bicycle, personal watercraft, boat, roller blades, skateboard, snowboard, skis, etc.) are increased due to, among other things, the fact that the vehicle itself provides virtually no impact protection in the event of an accident and the absence of passive restraint systems on such vehicles frequently result in rider becoming ejected or otherwise separated from the vehicle.

The widespread use of air bag devices in the automobile industry has lead to the development of air bag devices for motorcycles. For example, motorcycle-mounted airbag devices positioned in front of a rider have been proposed to absorb some of the rider's kinetic energy during a frontal collision. These motorcycle-mounted devices, however, do not protect a rider who is separated from the motorcycle and are generally deployed only when the motorcycle is involved in a frontal collision.

As an alternative to motorcycle-mounted air bag devices, airbag jackets to be worn by a rider exist for protecting the rider in the event the rider is ejected from the motorcycle in an accident. Such airbag jackets typically include a lanyard or cable that is anchored to the frame of the motorcycle. Should the rider be ejected from the motorcycle during an accident, the force on the lanyard causes a CO₂ cartridge within the jacket to rapidly inflate an airbag within the jacket.

While such airbag devices-whether mounted directly on the motorcycle or worn by the motorcyclist provide improved protection for the motorcyclist, each has limitations and there is a need for an improved airbag deployment system that can more accurately determine when deployment of the airbag is required.

### SUMMARY

In accordance with one aspect of this disclosure, an airbag deployment system and method is disclosed for an airbag equipped garment worn by a rider of a vehicle. The system and method comprise a controller for determining when to inflate an airbag within the garment. A first sensor provides a signal to the controller representing the riding angle of the vehicle relative to a vertical orientation. A second sensor provides a signal to the controller representing a current condition of the vehicle. The controller compares the riding angle to a first predetermined threshold indicative of the maximum desired riding angle associated with the current condition of the vehicle and transmits a signal to inflate the airbag when the riding angle exceeds the first predetermined threshold.

In accordance with another aspect of this disclosure, a system and method is disclosed for deploying an airbag within a garment worn by a rider of a vehicle. The system and method comprise determining an acceleration of the vehicle at a first time interval. The acceleration of the vehicle at the first time interval is compared to a first predetermined threshold indicative of a minimum acceleration for airbag deployment. The system and method determine whether the distance between the rider and the vehicle exceeds a second predetermined threshold indicative of the rider becoming separated from the vehicle. A signal to deploy the airbag is transmitted when the acceleration of the vehicle at the first time interval exceeds the first predetermined threshold and the distance between the rider and the vehicle exceeds the second predetermined threshold. The airbag inflates in response to the transmitted deployment signal.

In accordance with yet another aspect of this disclosure, a system and method is disclosed for deploying an airbag within a garment worn by a rider of a vehicle. The system and method comprise a controller for determining when to inflate an airbag within the garment. A first sensor mounted on the garment provides a signal to the controller representing an acceleration of the rider at a first time interval. A second sensor mounted on the vehicle provides a signal representing an acceleration of the vehicle at the first time interval. The controller compares the acceleration of the rider and the vehicle at the first time interval and transmits a signal to deploy the airbag when the difference between the acceleration of the rider and the vehicle at the first time interval exceeds a predetermined threshold.

These and other advantages of the present disclosure will be apparent to those of ordinary skill in the art by reference to the following detailed description and the accompanying drawings.

### BRIEF DESCRIPTION OF THE DRAWING

FIG. 1 is a front view of an airbag jacket in accordance with the present disclosure;

FIG. 2 is a rear view of the airbag jacket of FIG. 1;

FIG. 3 is a high level diagram of a control unit for controlling airbag deployment in accordance with the present disclosure;

FIG. 4 is a side elevation view of a representative motorcycle that may be utilized with the airbag jackets illustrated in FIGS. 1 and 2;

FIGS. 5A-5C are flow charts illustrating airbag deployment processing where all sensors are mounted on the motorcycle; and

FIGS. 6A and 6B are flow charts illustrating airbag deployment processing where all sensors are mounted in the airbag jacket worn by the rider.

### DETAILED DESCRIPTION

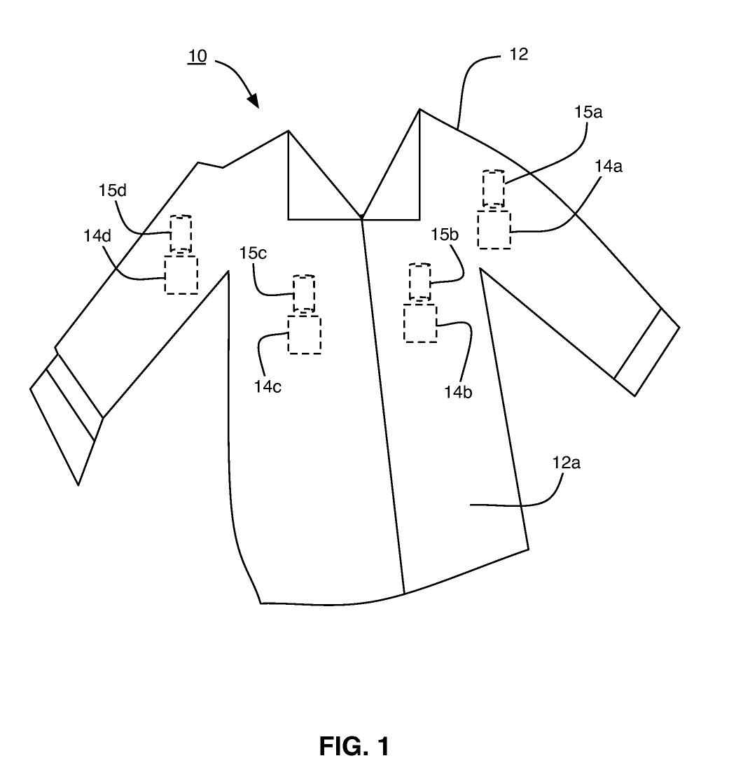

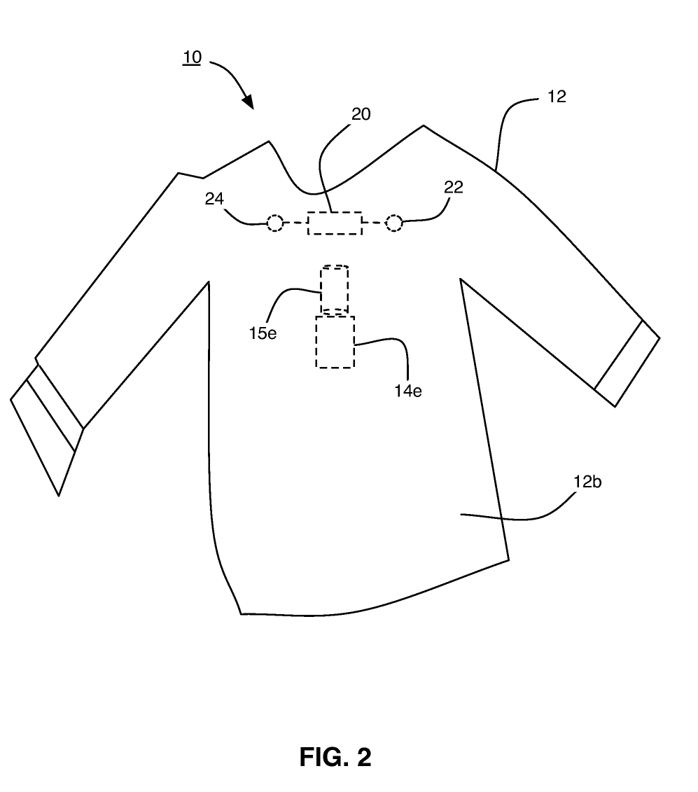

In accordance with the present disclosure, an airbag deployment system 10 for a rider of a motorcycle or other recreational vehicle (e.g., all terrain vehicle, snowmobile, bicycle, personal watercraft, boat, roller blades, skateboard, snowboard, skis, etc.) is disclosed. As illustrated in FIGS. 1 and 2, the airbag deployment system 10 includes an airbag jacket or garment 12 having a front 12a and rear 12b. While the present disclosure is described in connection with an airbag jacket 12, it is understood that the airbag deployment system 10 disclosed herein is not limited to use with an airbag jacket and may be used with other garments containing airbags worn by a rider, such as, for example, a vest, pants, one piece or two piece body suit, or the like.

The airbag jacket 12 preferably includes one or more inflatable airbags 14a-14f. While four airbags 14a-14d are illustrated on the front 12a of the jacket 12 and one airbag 14f on the rear 12b of the jacket, it is understood that the jacket 12 illustrated in FIGS. 1 and 2 is illustrative and that the present disclosure is not limited to the number and position of the airbags illustrated in the drawings. The number and location of the airbags in the jacket 12 should be sufficient to protect vulnerable portions of the rider's body, such as, for example, the rider's chest, abdomen, sides, back, spine and neck.

Each airbag 14a-14f is preferably connected via a fluid passageway to a pressurized gas source 15a-15f, which may be, for example, a cartridge containing CO₂ or any other suitable gas. Alternatively, multiple airbags may be fluidly connected to a single source of pressurized gas.

A controller 20 is preferably provided in the rear 12b of the airbag jacket 12 for processing signals received from various sensors on the airbag jacket and/or motorcycle (or other vehicle) to determine whether an event or condition has occurred that requires deployment of the airbags 14a-14f. Such conditions include an abnormal riding angle and/or an abnormal separation between the rider and the vehicle. These conditions may involve sudden and rapid increase in the distance between the vehicle and rider, and rapid acceleration/deceleration of the rider and/or vehicle. The airbag deployment system 10 may use a variety of sensors to recognize an abnormal separation event. The sensors may be mounted on or otherwise built into the jacket 12 and/or mounted on the vehicle.

Once the controller 20 identifies a deployable event (e.g., an abnormal separation), it will trigger one or more conventional activation devices built into the jacket 12 to rapidly inflate the airbags 14a-14f in the jacket to protect the rider. Conventional activation devices may include, for example, a firing pin that pierces the pressurized gas source 15a-15f (e.g., CO₂ cartridge) in response to a deployment signal from the controller 20. When inflated, these airbags 14a-14f preferably hug or engulf the rider to absorb impact forces should the rider strike or otherwise collide with an object or the road.

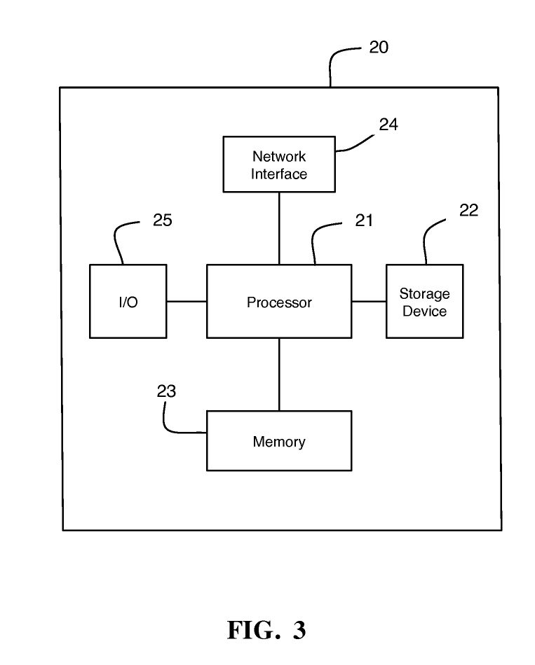

A high level diagram of a control unit 20 for controlling airbag deployment is illustrated in FIG. 3. The control unit 20 preferably includes a processor 21 that controls the overall operation of the control unit by executing computer program instructions defining such operation. The computer program instructions may be stored in a storage device 22 (e.g., magnetic disk) or any other computer-readable medium, and loaded into memory 23 when execution of the computer program instructions is desired. Controller 20 may also include one or more network interfaces 24 for communicating via a wired or wireless network with other devices (e.g., components/sensors in the system 10). Controller 20 may also include input/output (“I/O”) devices 25, which represent various sensors located in the jacket 12 and/or on the vehicle, activation devices for releasing the pressurized gas source 15a-15f into the airbags 14a-14f, and devices allowing for user interaction with controller 20 (e.g., display, keyboard, mouse, speakers, buttons, etc.). One skilled in the art will recognize that the controller 20 illustrated in FIG. 3 is illustrative and that the controller 20 may contain additional components.

At a minimum, the airbag deployment system 10 requires only one sensor-an accelerometer. The controller 20 receives a signal from the accelerometer indicative of the rider's acceleration and processes this signal at various stages of the ride. Since the rider is mounted on the vehicle during operation, the rider's acceleration is the same as the vehicle acceleration. The controller 20 compares the rider's acceleration/deceleration to a predetermined threshold and transmits a signal to deploy the airbags 14a-14f within jacket/garment 12 in the event that the rider's acceleration/deceleration exceeds the predetermined threshold. The airbags 14a-14f are then rapidly inflated with gas from pressurized gas source 15a-15f (e.g., CO₂ cartridge) in response to the deployment signal from controller 20.

The acceleration/deceleration threshold may be determined by formula or read from memory storage by the controller 20. The threshold may depend on one or more factors, such as, for example, current speed v, weight/size of the rider and type/capability of the vehicle.

By way of example, if a rider were traveling steadily at 50 mph, the rider's acceleration would be zero. Should the rider's acceleration suddenly change to some value, the controller 20 will determine whether that change in acceleration is “normal” to the operation of the vehicle. If not, then the controller 20 will transmit a signal to deploy the airbags 14a-14f within the airbag jacket/garment 12 worn by the rider. So, if the rider were separated or ejected from the vehicle (e.g., airborne) and was continually decelerating (e.g., slowing down from 50 mph to zero) at a rate consistent with the rider's properties, then the controller 20 would transmit a signal to deploy the airbags 14a-14f within the airbag jacket/garment 12 worn by the rider. To minimize false deployment of the airbags, the controller 20 would preferably verify the existence of the deployment condition by taking additional samples of the acceleration/deceleration prior to transmitting the signal to deploy the airbags.

As an alternative to a single accelerometer, the airbag deployment system 10 may use two or more accelerometers. One or more accelerometers are mounted on the vehicle and one or more accelerometers are mounted on the airbag jacket/garment 12. The controller 20 receives signals from each of the accelerometers and compares the acceleration of the vehicle to that of the rider wearing the airbag jacket/garment 12. If the values associated with the acceleration of the vehicle and the acceleration of the rider are similar or within a predetermined range of one another, the controller 20 will consider this a normal condition. However, if the difference between the acceleration of the vehicle and the rider exceeds this predetermined range, then the controller 20 will consider this a deployable condition and transmit a signal to deploy the airbags 14a-14f within the airbag jacket/garment 12 worn by the rider. To minimize false deployment of the airbags, the controller 20 may verify the existence of the deployment condition by comparing additional samples of the acceleration/deceleration of the vehicle and rider prior to transmitting the signal to deploy the airbags.

The airbag deployment system 10 may be utilized in three different configurations: (1) with all sensors and separation logic mounted on the motorcycle or other vehicle; (2) with all sensors and separation logic mounted on the jacket 12 worn by the rider; or (3) with sensors and separation logic mounted on both the vehicle and the jacket.

Examples of each of these configurations are described more fully below.

Configuration 1: All Sensors Mounted on the Vehicle

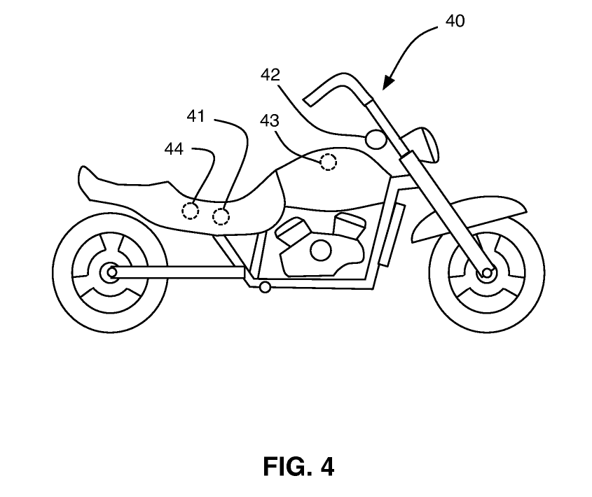

In this configuration, all of the sensors and separation logic are mounted on the motorcycle/vehicle 40. The sensors to be utilized with the airbag deployment system 10 may include, but are not limited to, a conventional gyroscope 41, speedometer/accelerometer 42 and proximity/distance sensor 43 mounted on the motorcycle 40 as shown, for example, in FIG. 4. The sensors 41, 42 and 43 may communicate wirelessly with the controller 20 using conventional transmitters that generate, for example, infra red (“IR”), radio frequency (“RF”), Bluetooth, WiFi or other wireless signals. The controller 20 preferably includes a conventional receiver for receiving and processing wireless signals generated by the sensors 41, 42 and 43.

In this configuration, the airbag deployment system 10 detects an abnormal riding angle or rapid deceleration of the motorcycle 40 as one indicator that the rider has become separated from the vehicle requiring deployment of airbags 14a-14f in jacket/garment 12. The system 10 also detects rapid increase in distance measured or physical separation of the rider from the motorcycle/vehicle 40 as another indicator that the rider has become separated from the motorcycle requiring deployment of airbags 14a-14f in jacket 12.

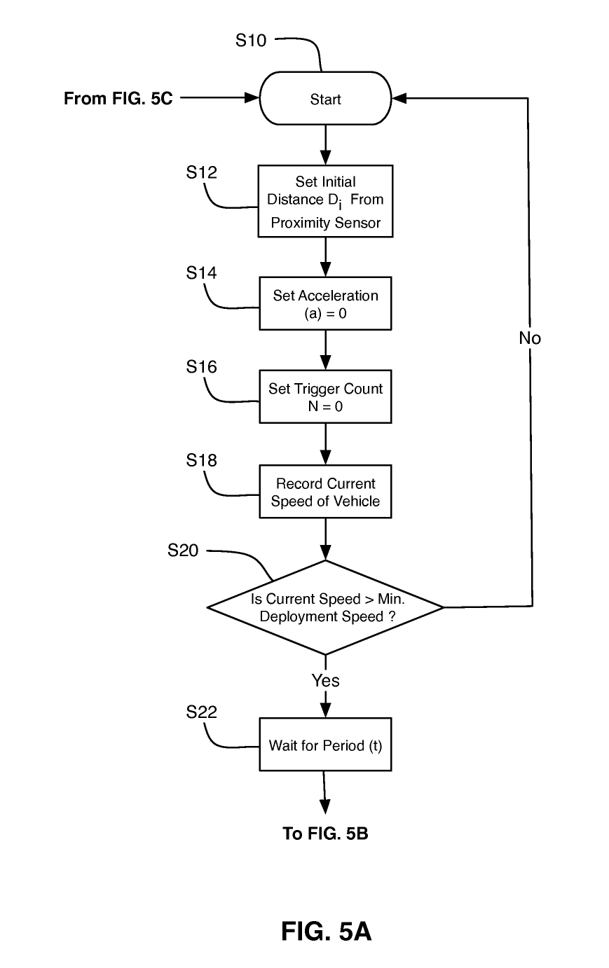

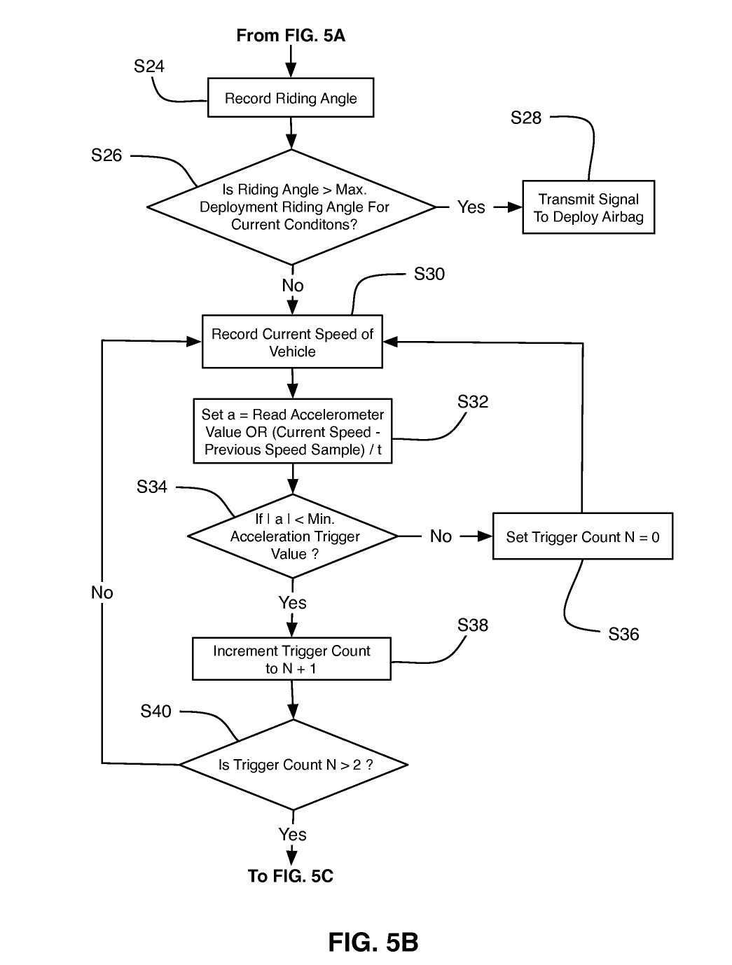

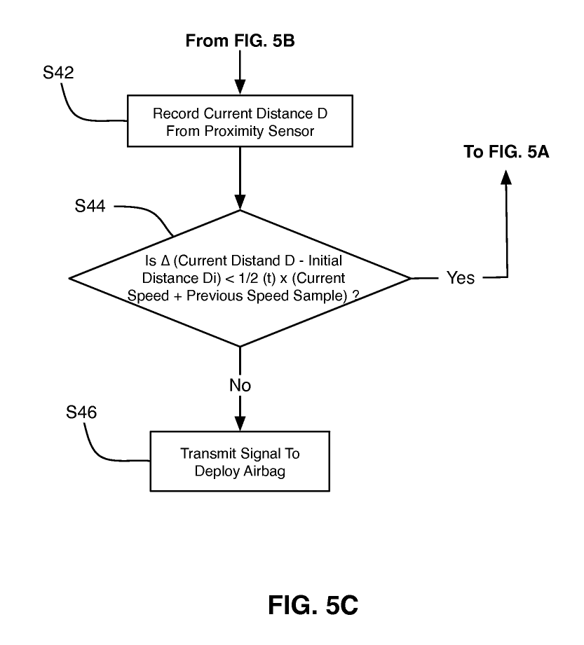

FIGS. 5A-5C illustrate a preferred airbag deployment processing sequence where all sensors are mounted on the motorcycle/vehicle 40. The airbag deployment system 10 is initiated in step S10. In step S12, the controller 20 records or sets the initial distance Dᵢ that the rider is from the proximity sensor 43 based on the signal received from the sensor 43.

In step S14, the controller 20 sets the acceleration a associated with the rider to zero. In step S16, the controller 20 sets the trigger count N to zero. The trigger count N is preferably utilized to ensure or verify that a deployment condition exists before deploying the airbags (as opposed to a false deployment that may injure a rider) by requiring multiple samples.

As part of an acceleration detection loop, the controller 20 records the current speed v of the rider in step S18 based on a signal received from the speedometer 42. In step S20, the controller 20 determines whether the recorded current speed v exceeds a minimum deployment speed vₘᵢₙ or threshold (e.g., 30 mph). The minimum deployment speed vₘᵢₙ may be preprogrammed into the storage device 22 or memory 23 of the controller 20, or may be set by the rider using, for example, a dial, keypad, or other wired or remote input device to set the minimum deployment speed vₘᵢₙ, in the controller 20.

If the current speed v is less than or equal to the predetermined minimum deployment speed vₘᵢₙ, the controller 20 will preferably reinitiate the process by looping back to step S10.

On the other hand, if the controller 20 determines that the current speed v exceeds the predetermined minimum deployment speed vₘᵢₙ in step S20, the controller 20 will delay further processing in step S22 for a period t, which may be, for example, 0.1 seconds. Thereafter, in step S24, the controller 22 will record the riding angle Ø based on a signal received from the gyroscope 41.

In step S26, the controller 20 determines whether the riding angle Ø exceeds a preset threshold or maximum deployment riding angle Øₘₐₓ for the current conditions. This preset threshold or maximum deployment riding angle Øₘₐₓ for the current conditions may be derived using a formula to determine the range of safe/normal riding angles. This formula may consider multiple factors, including, but not limited to the current speed v of the vehicle/rider, the type of tire mounted on the vehicle and/or current tire pressure p (which may be obtained based on a signal transmitted to the controller from a sensor mounted on the tire or vehicle).

If the riding angle Ø exceeds the preset threshold or maximum deployment riding angle Øₘₐₓ for the current conditions, then the controller 20 transmits a signal to deploy the airbags 14a-14f in step S28, which are then rapidly inflated with gas from pressurized gas source 15a-15f (e.g., CO₂ cartridge) in response to the deployment signal from controller 20.

If, however, the controller 20 determines in step S26 that the riding angle Ø does not exceed the preset threshold or maximum deployment riding angle Øₘₐₓ for the current conditions, then the controller 20 records the current speed v of the rider/motorcycle 40 in step S30 based on the signal received from the speedometer 42. In step S32, the controller 20 determines or otherwise sets the acceleration a by calculating the difference between the current speed v and the previous speed sample v (recorded in step S18) divided by the period t (e.g., 0.1 seconds). Alternatively, if an accelerometer is used as the sensor 42, the controller 20 may determine or otherwise set the acceleration a in step 32 to the value associated with the signal received from the accelerometer 42.

In step S34, the controller 20 determines whether the absolute value of a (from step S32) exceeds a minimum acceleration trigger value aₘᵢₙ. This value aₘᵢₙ may be, for example, a variable greater than 4.0 m/s². Its precise value may be set by the user or preprogrammed into the controller 20. A higher acceleration rate indicates less sensitive separation detection.

If the absolute value of a does not exceed the minimum acceleration trigger value aₘᵢₙ, then the controller 20 resets the trigger count N to zero in step S36 and the process loops back to step S30.

On the other hand, if the controller 20 determines in step S34 that the absolute value of a exceeds the minimum acceleration trigger value aₘᵢₙ, then the controller preferably sets or otherwise increments the trigger count by one unit (N+1) in step S38. To minimize the chance of false deployment of the airbags, the controller 20 preferably determines in step S40 whether the trigger count N is greater than two (or any other number of samples required for verification of a deployment condition prior to airbag deployment).

If the trigger count does not exceed two in step S40, then the process will loop back to step S30 to take another sample. Alternatively, if the trigger count exceeds two in step S40, then the controller 20 preferably records the current distance D between the rider and the proximity sensor 43 in step S42 based on the signal received from the proximity sensor 43.

To provide further confirmation of an abnormal separation, the distance between the rider and the vehicle may be measured. In step S44, the controller 20 determines whether the delta Δ between the current distance D (from step S42) and the initial distance Dᵢ (from step S12) exceeds the sum of the current speed v (from step S30) and the previous speed sample multiplied by ½ of time t. If so, then the controller 20 transmits a signal to deploy the airbags 14a-14f in step S46, which are then rapidly inflated with gas from pressurized gas source 15a-15f (e.g., CO₂ cartridge) in response to the deployment signal from controller 20. If not, then the process loops back to step S10 to reinitiate sampling.

As mentioned above, an optional accelerometer 44 may be mounted on the motorcycle 40 to measure acceleration and transmit such measurements wirelessly to the controller 20. In this manner, the acceleration detection loop in steps S18, S30 and S32 may be omitted.

It is also understood that the controller 20 may be mounted on the motorcycle/vehicle 40 and that the controller may deploy the airbags 14a-14f in the jacket/garment 12 by transmitting a wireless signal to a receiver mounted on the jacket, which would cause the pressurized gas source 15a-15f (e.g., CO₂ cartridge) to rapidly inflate the airbags in response to the deployment signal from controller 20.

Similarly, as an alternative to calculating the distance D between the rider and the motorcycle using proximity sensor 43, an optional switch or pressure sensor may be mounted in proximity to the seat on the motorcycle 40. When the rider is off the seat, the switch or pressure sensor would close to indicate separation of the rider from the seat. In this manner, the proximity sensor 43 may not be required and can be ignored in the process steps discussed above. Instead, the controller 20 would preferably verify in step S46 that the optional switch or pressure sensor was closed (indicating separation of the rider from the motorcycle/vehicle) before deployment of the airbags.

Configuration 2: All Sensors and Separation Logic Mounted on the Rider's Jacket

In this configuration, all of the sensors and separation logic are mounted on the airbag jacket or other garment 12 worn by the rider. The sensors to be utilized with the airbag deployment system 10 in this configuration preferably include, but are not limited to, a conventional gyroscope, accelerometer and proximity/distance sensor. The gyroscope, accelerometer and proximity sensor may be wired to the controller 20. Alternatively, the gyroscope, accelerometer and proximity sensor can communicate wirelessly with the controller 20 using conventional transmitters that generate, for example, IR, RF, Bluetooth, WiFi or other wireless signals. The controller 20 may include a conventional receiver for receiving and processing wireless signals generated by the sensors.

In this configuration, the airbag deployment system 10 may detect an abnormal riding angle or rapid acceleration of the rider wearing the jacket 12 as one indicator that the rider has become separated from the motorcycle/vehicle requiring deployment of airbags 14a-14f in jacket 12. The airbag deployment system 10 may also detect rapid increase in distance measured or physical separation of the rider from the motorcycle/vehicle as a further indicator that the rider has become separated from the motorcycle/vehicle requiring deployment of airbags 14a-14f in jacket 12.

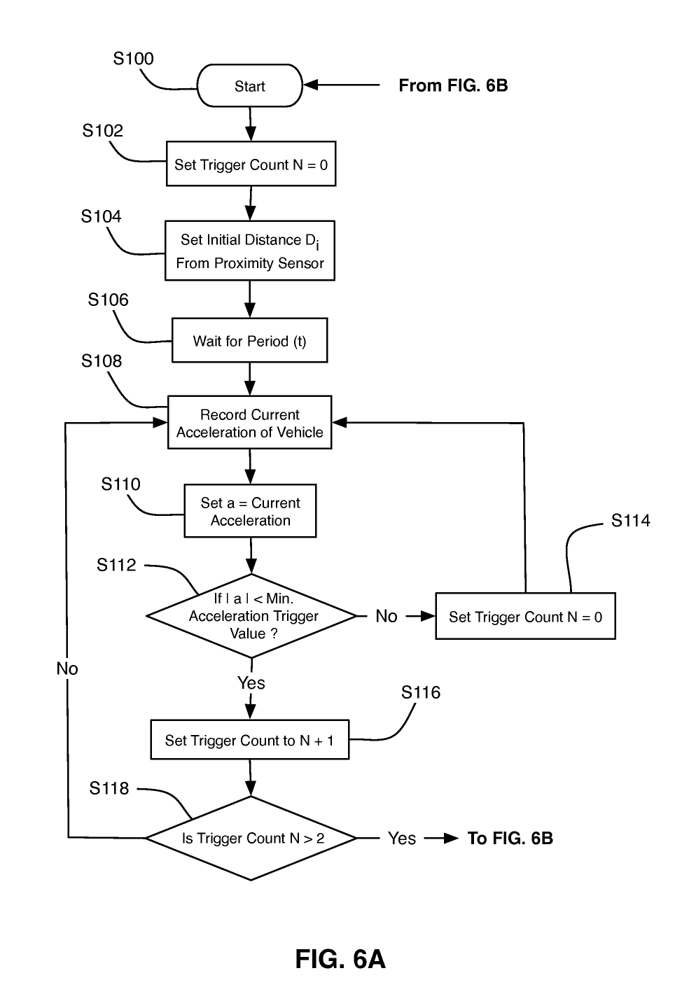

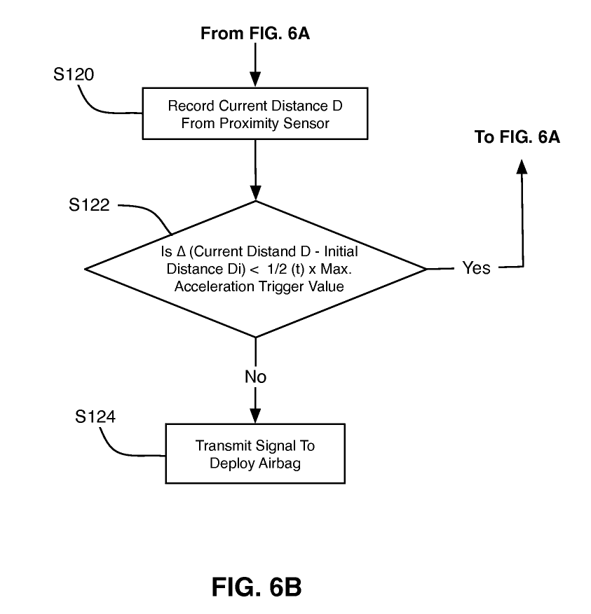

FIGS. 6A-6B illustrate a preferred airbag deployment processing sequence where all sensors and separation logic are mounted in the airbag jacket/garment 12. The airbag deployment system 10 is initiated in step S100. In step S102, the controller 20 sets the trigger count N to zero. The trigger count N is preferably utilized to ensure or verify that a deployment condition exists before deploying the airbags (as opposed to a false deployment that may injure a rider) by requiring multiple samples.

In step S104, the controller 20 records or sets the initial distance Dᵢ that the rider is from the motorcycle based on a signal from the proximity sensor mounted in the jacket 12. In step S106, the controller 20 will delay further processing for a period t, which may be, for example, 0.1 seconds.

In step S108, the controller 20 records the acceleration a of the rider based on the signal received from the accelerometer mounted in the jacket 12. The controller 20 sets the recorded acceleration a as the current acceleration in step S110.

In step S112, the controller 20 determines whether the absolute value of a (from step S110) exceeds a predetermined minimum acceleration trigger value aₘᵢₙ. This value aₘᵢₙ may be, for example, a variable greater than 4.0 m/s². Its precise value may be set by the user or preprogrammed into the controller. A higher acceleration rate indicates less sensitive separation detection.

If the absolute value of a does not exceed the minimum acceleration trigger value aₘᵢₙ, then the controller 20 resets the trigger count N to zero in step S114 and the process loops back to step S108.

On the other hand, if the controller 20 determines in step S112 that the absolute value of a exceeds the minimum acceleration trigger value aₘᵢₙ, then the controller sets or otherwise increments the trigger count by one unit (N+1) in step S116. To minimize the chance of false deployment of the airbags, the controller 20 preferably determines in step S118 whether the trigger count N is greater than two (or any other number of samples required to verify the existence of a deployment condition prior to airbag deployment).

If the trigger count does not exceed two in step S118, then the process will loop back to step S108 to take another sample. Alternatively, if the trigger count exceeds two in step S118, then the controller 20 records the current distance D between the rider and the motorcycle/vehicle in step S120 based on the signal received from the proximity sensor.

In step S122, the controller 20 determines whether the delta A between the current distance D (from step S120) and the initial distance Dᵢ (from step S104) exceeds a maximum acceleration trigger value aₘₐₓ multiplied by ½ of time t. This value aₘₐₓ may be, for example, a variable greater than 4.0 m/s². Its precise value may be set by the user or preprogrammed into the controller by the manufacturer. A higher acceleration rate indicates less sensitive separation detection.

If the controller determines that the delta A exceeds the maximum acceleration trigger value aₘₐₓ multiplied by ½ of time t in step S122, then the controller 20 transmits a signal to deploy the airbags 14a-14f in step S124, which are then rapidly inflated with gas from pressurized gas source 15a-15f (e.g., CO₂ cartridge) in response to the deployment signal from controller 20. If not, then the process loops back to step S100 to reinitiate sampling.

Optionally, the controller 20 may also determine whether the riding angle Ø exceeds a preset threshold or maximum deployment riding angle Øₘₐₓ for the current conditions. This preset threshold or maximum deployment riding angle Øₘₐₓ for the current conditions may be derived using a formula to determine the range of safe/normal riding angles. This formula may consider multiple factors, including, but not limited to the current speed v of the vehicle/rider, the type of tire mounted on the vehicle and/or current tire pressure p (which may be obtained based on a signal transmitted to the controller from a sensor mounted on the tire or vehicle). The riding angle Ø may be determined based on the signal from the gyroscope within the jacket 12. If the riding angle Ø exceeds the maximum deployment riding angle Øₘₐₓ for the current conditions, then the controller 20 transmits a signal to deploy the airbags 14a-14f, which are then rapidly inflated with gas from pressurized gas source 15a-15f (e.g., CO₂ cartridge) in response to the deployment signal from controller 20.

As an alternative to calculating the distance between the rider and the motorcycle using a proximity sensor mounted in the airbag jacket 12, an optional switch or pressure sensor may be mounted in proximity to the seat on the motorcycle. When the rider is off the seat, the switch or pressure sensor would close to indicate separation of the rider from the seat. In this manner, the proximity sensor may not be required in the airbag jacket and can be ignored in the process steps discussed above. Instead, the controller 20 would preferably verify that the optional switch or pressure sensor was closed (indicating separation of the rider from the motorcycle) before deployment of the airbags.

Configuration 3: Sensors and Separation Logic are Split Between the Vehicle and Airbag Jacket

In this configuration, the sensors and separation logic may be mounted on the airbag jacket or other garment 12 worn by the rider or on the motorcycle/vehicle. Communication between the sensors and the controller may be accomplished using a wireless protocol. The process steps for deployment of the airbags 14a-14f may be the same as described above in either configuration 1 or 2.

As mentioned above, while the present disclosure is described above in connection with an airbag jacket 12, it is understood that the airbag deployment system 10 disclosed herein is not limited to use with an airbag jacket and may be used with other garments containing airbags worn by a rider, such as, for example, a vest, pants, one piece or two piece body suit, or the like. The garment may, therefore, be a full body suit, upper body only, lower body only or two piece suit. In the case of a two piece suit, the two sections may act independently of each other or one may act as a slave to the other.

It is further understood that the airbag deployment system described herein is not intended to be limited to use with a motorcycle and is intended to be applicable for protecting a rider on other recreational vehicles (e.g., all terrain vehicles, snowmobiles, bicycles, personal watercraft, boats, roller blades, skateboards, snowboards, skis, etc.).

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A method for deploying an airbag within a garment worn by a rider on a vehicle, comprising:
receiving a signal representing the riding angle of the vehicle relative a vertical orientation;
comparing the riding angle to a first predetermined threshold indicative of a maximum desired riding angle;
transmitting a signal to deploy the airbag when the riding angle exceeds the first predetermined threshold; and
inflating the airbag in response to the transmitted deployment signal.

2. The method according to claim 1, further comprising:
storing a plurality of first predetermined thresholds indicative of the maximum riding desired angle for different conditions of the vehicle;
receiving a signal representative of a current condition of the vehicle; and
retrieving the first predetermined threshold for the current condition of the vehicle.

3. The method according to claim 2, wherein the current condition comprises a speed of the vehicle.

4. The method according to claim 2, further comprising:
comparing the current speed of the vehicle to a second predetermined threshold indicative of the minimum speed for deployment of airbags;
wherein the signal to deploy the airbag is not transmitted if the current speed of the vehicle does not exceed the second predetermined threshold.

5. The method according to claim 1, further comprising:
determining an acceleration of the vehicle at a first time interval;
comparing the acceleration of the vehicle at the first time interval to a third predetermined threshold indicative of a minimum acceleration for airbag deployment.

6. The method according to claim 5, further comprising:
determining whether the distance between the rider and the vehicle exceeds a fourth predetermined threshold indicative of the rider becoming separated from the vehicle;
transmitting a signal to deploy the airbag when the distance between the rider and the vehicle exceeds the fourth predetermined threshold; and
inflating the airbag in response to the transmitted deployment signal.

7. The method according to claim 6, further comprising:
determining the acceleration of the vehicle at a second time interval; and
comparing the acceleration of the vehicle at the second time interval to the third predetermined threshold;
wherein the signal to deploy the airbag when the distance between the rider and the vehicle exceeds the fourth predetermined threshold is transmitted if the acceleration of the vehicle at both the first and second time intervals exceeds the third predetermined threshold.

8. An airbag deployment system for an airbag equipped garment worn by a rider of a vehicle, comprising:
a controller for determining when to inflate an airbag within the garment;
a first sensor for providing a signal to the controller representing the riding angle of the vehicle relative to a vertical orientation; and
a second sensor for providing a signal to the controller representing a current condition of the vehicle;
wherein the controller compares the riding angle to a first predetermined threshold indicative of the maximum desired riding angle associated with the current condition of the vehicle and transmits a signal to inflate the airbag when the riding angle exceeds the first predetermined threshold.

9. The system according to claim 8, wherein the current condition comprises a current speed of the vehicle.

10. The system according to claim 9, wherein the controller compares the current speed of the vehicle to a second predetermined threshold indicative of a minimum speed for deployment of airbags and does not transmit the signal to deploy the airbag if the current speed of the vehicle does not exceed the second predetermined threshold.

11. The system according to claim 8, wherein the first sensor is a gyroscope located on the vehicle.

12. The system according to claim 8, wherein the first sensor is a gyroscope located on the airbag equipped garment.

13. The system according to claim 8, wherein the second sensor is a speed sensor located on the vehicle.

14. The system according to claim 8, wherein the second sensor is a speed sensor located on the airbag equipped garment.

15. The system according to claim 8, further comprising a third sensor for providing a signal to the controller representative of the acceleration of the vehicle at a first time interval, wherein the controller compares the acceleration of the vehicle at the first time interval to a third predetermined threshold indicative of a minimum acceleration for airbag deployment.

16. The system according to claim 15, wherein the third sensor is an accelerometer located on the vehicle.

17. The system according to claim 15, wherein the third sensor is an accelerometer located on the airbag equipped garment.

18. The system according to claim 15, further comprising a fourth sensor for determining whether the distance between the rider and the vehicle exceeds a fourth predetermined threshold indicative of the rider becoming separated from the vehicle, wherein the controller transmits a signal to inflate the airbag when the distance between the rider and the vehicle exceeds the fourth predetermined threshold.

19. The system according to claim 18, wherein the fourth sensor is a proximity sensor located on the vehicle.

20. The system according to claim 18, wherein the fourth sensor is a proximity sensor located on the airbag equipped garment.

21. The system according to claim 18, wherein the fourth sensor is a switch mounted on the vehicle for detecting whether the rider is seated on the vehicle.

22. A method for deploying an airbag within a garment worn by a rider of a vehicle, comprising:
determining an acceleration of the vehicle at a first time interval;
comparing the acceleration of the vehicle at the first time interval to a first predetermined threshold indicative of a minimum acceleration for airbag deployment;
determining whether the distance between the rider and the vehicle exceeds a second predetermined threshold indicative of the rider becoming separated from the vehicle;
transmitting a signal to deploy the airbag when the acceleration of the vehicle at the first time interval exceeds the first predetermined threshold and the distance between the rider and the vehicle exceeds the second predetermined threshold; and
inflating the airbag in response to the transmitted deployment signal.

23. The method according to claim 22, further comprising:
determining the acceleration of the vehicle at a second time interval; and
comparing the acceleration of the vehicle at the second time interval to the first predetermined threshold;
wherein the signal to deploy the airbag is transmitted if the acceleration of the vehicle at both the first and second time intervals exceeds the first predetermined threshold and the distance between the rider and the vehicle exceeds the second predetermined threshold.

24. The method according to claim 22, further comprising:
receiving a signal representing the riding angle of the vehicle relative to a vertical orientation;
comparing the riding angle to a third predetermined threshold indicative of a maximum riding angle;
transmitting a signal to deploy the airbag when the riding angle exceeds the third predetermined threshold; and
inflating the airbag in response to the transmitted deployment signal.

25. The method according to claim 24, further comprising:
storing a plurality of third predetermined thresholds indicative of the maximum riding angle associated with different conditions of the vehicle;
receiving a signal representative of a current condition of the vehicle; and
retrieving the third predetermined threshold for the current condition of the vehicle.

26. The method according to claim 25, wherein the current condition comprises a speed of the vehicle.

27. The method according to claim 24, further comprising:
comparing a current speed of the vehicle to a fourth predetermined threshold indicative of a minimum speed for deployment of airbags;
wherein the signal to deploy the airbag is not transmitted if the current speed of the vehicle does not exceed the fourth predetermined threshold.

28. An airbag deployment system for an airbag equipped garment worn by a rider of a vehicle, comprising:
a controller for determining when to inflate an airbag within the garment;
a first sensor for providing a signal to the controller representing an acceleration of the vehicle at a first time interval;
a second sensor for providing a signal representing whether the distance between the rider and the vehicle exceeds a second predetermined threshold indicative of the rider becoming separated from the vehicle;
wherein the controller compares the acceleration of the vehicle at the first time interval to a first predetermined threshold indicative of a minimum acceleration for airbag deployment and transmits a signal to deploy the airbag when the acceleration of the vehicle at the first time interval exceeds the first predetermined threshold and the distance between the rider and the vehicle exceeds the second predetermined threshold.

29. The system according to claim 28, wherein the controller receives a signal from the first sensor indicative of the acceleration of the vehicle at a second time interval and does not transmit the signal to deploy the airbag unless the acceleration of the vehicle at both the first and second time intervals exceeds the first predetermined threshold and the distance between the rider and the vehicle exceeds the second predetermined threshold.

30. The system according to claim 28, wherein the first sensor is an accelerometer.

31. The system according to claim 28, wherein the first sensor is a speed sensor.

32. The system according to claim 28, wherein the first sensor is located on the vehicle.

33. The system according to claim 28, wherein the first sensor is located on the airbag equipped garment.

34. The system according to claim 28, wherein the second sensor is a proximity sensor located on the vehicle.

35. The system according to claim 28, wherein the second sensor is a proximity sensor located the airbag equipped garment.

36. The system according to claim 28, wherein the second sensor is a switch mounted on the vehicle for detecting whether the rider is seated on the vehicle.

37. The system according to claim 28, further comprising:
a third sensor for providing a signal to the controller representing the riding angle of the vehicle relative to a vertical orientation; and
a fourth sensor for providing a signal to the controller representing a current condition of the vehicle;
wherein the controller compares the riding angle to a third predetermined threshold indicative of the maximum desired riding angle associated with the current condition of the vehicle and transmits a signal to inflate the airbag when the riding angle exceeds the third predetermined threshold.

38. The system according to claim 37, wherein the current condition comprises a current speed of the vehicle.

39. The system according to claim 38, wherein the controller compares the current speed of the vehicle to a fourth predetermined threshold indicative of a minimum speed for deployment of airbags and does not transmit the signal to deploy the airbag if the current speed of the vehicle does not exceed the fourth predetermined threshold.

40. The system according to claim 37, wherein the third sensor is a gyroscope located on the vehicle.

41. The system according to claim 37, wherein the third sensor is a gyroscope located on the airbag equipped garment.

42. The system according to claim 37, wherein the fourth sensor is a speed sensor located on the vehicle.

43. The system according to claim 37, wherein the fourth sensor is a speed sensor located on the airbag equipped garment.

44. A method for deploying an airbag within a garment worn by a rider of a vehicle, comprising:
determining an acceleration of the rider at a first time interval;
determining the acceleration of the vehicle at the first time interval;
comparing the acceleration of the rider at the first time interval to the acceleration of the vehicle at the first time interval; and
transmitting a signal to deploy the airbag when the difference between the acceleration of the rider at the first time interval and the acceleration of the vehicle at the first time interval exceeds a first predetermined threshold; and
inflating the airbag in response to the transmitted deployment signal.

45. The method according to claim 44, further comprising:
determining the acceleration of the rider at a second time interval;
determining the acceleration of the vehicle at a second time interval; and
comparing the acceleration of the rider at the second time interval to the acceleration of the vehicle at the second time interval;
wherein the signal to deploy the airbag is transmitted if the difference between the acceleration of the rider and the acceleration of the vehicle at both the first and second time intervals exceeds the predetermined threshold.

46. The method according to claim 44, wherein the acceleration of the rider is determined based on a signal received from a first sensor mounted on the garment worn by the rider and the acceleration of the vehicle is determined based on a signal received from a second sensor mounted on the vehicle.

47. The method according to claim 46, wherein the first sensor is an accelerometer and the second sensor is an accelerometer.

48. An airbag deployment system for an airbag equipped garment worn by a rider of a vehicle, comprising:
a controller for determining when to inflate an airbag within the garment;
a first sensor mounted on the garment for providing a signal to the controller representing an acceleration of the rider at a first time interval;
a second sensor mounted on the vehicle for providing a signal representing an acceleration of the vehicle at the first time interval;
wherein the controller compares the acceleration of the rider and the vehicle at the first time interval and transmits a signal to deploy the airbag when the difference between the acceleration of the rider and the vehicle at the first time interval exceeds a predetermined threshold.

49. The system according to claim 48, wherein the first sensor is an accelerometer and the second sensor is an accelerometer.
